(19) United States
(12) Patent Application Publication
(10) Pub. No.: US 2005/0106430 A1
(43) Pub. Date: May 19, 2005

(54) Hydrogen supply device and fuel-cell system

(76) Inventors: Koji Yamada, Osaka (JP); Hirohisa Tanaka, Osaka (JP); Kazuaki Yasuda, Osaka (JP); Zyun Sirowa, Osaka (JP); Yoshinori Miyazaki, Osaka (JP)

Correspondence Address: DICKINSON WRIGHT PLLC, 1901 L. STREET NW, SUITE 800, WASHINGTON, DC, 20036, US

(21) Appl. No.: 10/926,244

(22) Filed: Aug. 26, 2004

(30) Foreign Application Priority Data
Aug. 28, 2003 (JP) 2003-209192

(51) Int. Cl. H01M 8/06; C25B 9/00

(52) U.S. Cl. 429/21; 204/252

(57) ABSTRACT

A fuel cell system that can realize generation of electrical energy with improved energy efficiency as well as with a simplified construction of the system, and a hydrogen supply device used in the fuel cell system. The fuel cell system 1 comprises a fuel cell unit 4 using hydrogen as a fuel, and a hydrogen supply device 3 to supply hydrogen gas to the fuel cell unit 4. The hydrogen supply device 3 comprises a fuel-side electrode 8 to decompose a fuel whose standard oxidation-reduction potential is equal to or less than zero, a hydrogen-production-side electrode 9 for producing hydrogen, and an electrolyte membrane 10 interposed between them. This hydrogen supply device 3 can promote a spontaneous electrolytic reaction of the fuel whose standard oxidation-reduction potential is equal to or less than zero. This enables elimination of the need of an external power source for triggering the electrolytic reaction, simplification in construction of the system, and further, generation of the hydrogen with improved energy efficiency. Thus, this fuel cell system 1 can realize the generation of electrical energy with improved energy efficiency as well as with a simplified construction of the system.

### BACKGROUND OF THE INVENTION

This application is based on application No.2003-209192 filed in Japan, the content of which is incorporated hereinto by reference.

1. Field of the Invention

The present invention relates to a hydrogen supply device and to a fuel-cell system. More particularly, the present invention relates to a hydrogen supply device for supplying hydrogen to a fuel cell unit using hydrogen as a fuel and to a fuel-cell system comprising the hydrogen supply device and the fuel cell unit to which hydrogen is supplied from the hydrogen supply device.

2. Description of the Prior Art

A variety of polymer electrolyte membrane fuel cells (proton-exchange membrane fuel cells) using hydrogen gas as a fuel have been proposed to date. In general, the polymer electrolyte membrane fuel cell has the structure wherein a hydrogen-side electrode and an oxygen-side electrode are placed opposite to each other to sandwich a polymer electrolyte membrane therebetween. Hydrogen is supplied to the hydrogen side electrode and the air is supplied to the oxigen side electrode, to produce protons H⁺ and electrons e⁻ from the hydrogen on the hydrogen side electrode. The protons H⁺ produced are forced to pass through the polymer electrolyte membrane and shift to the oxygen-side electrode and also the electrons e⁻ produced are forced to pass through an external circuit and shift to the oxygen-side electrode, so that these protons and electrons are allowed to react with the oxygen on the oxygen-side electrode to produce water, thereby producing an electromotive force.

The polymer electrolyte membrane fuel cells of this type are being developed mainly in the automotive use, and a variety of proposals have been made for obtaining hydrogen as a fuel of an automotive vehicle, including, for example, providing on the automotive vehicle a reformer for reforming methanol or gasoline fed to the reformer as the fuel to obtain hydrogen therefrom, in addition to providing an onboard high-pressure hydrogen cylinder or an onboard liquefied hydrogen cylinder directly on the automotive vehicle.

For example, JP Laid-open (Unexamined) Patent Publication No. 2002-252017 proposes a methanol fuel cell having an electrolyzing unit for producing hydrogen by an electrolytic reaction of methanol, combined in series with a fuel cell unit for generating electric power from hydrogen, and oxygen or air.

This methanol fuel cell is designed to take out hydrogen from methanol by the electrolytic reaction in the electrolyzing unit so that the hydrogen can be used as the fuel to operate the fuel cell unit. This methanol fuel can generate electricity with high energy efficiency, while reducing a crossover phenomenon, despite of using methanol as the fuel.

However, this methanol fuel cell of JP Laid-open (Unexamined) Patent Publication No. 2002-252017 requires an external power source for triggering the electrolytic reaction of methanol first in the electrolyzing unit at the starting of operation of the fuel cell, and a power supply member for supplying the electric power generated in the fuel cell unit to the electrolyzing unit after the operation of the fuel cell unit, resulting in a complicated construction of the system.

In addition, since a part of the electric power generated in the fuel cell unit is supplied to the electrolyzing unit, the energy efficiency is unavoidably reduced to that extent.

### SUMMARY OF THE INVENTION

It is an object of the present invention to provide a fuel cell system that can realize generation of electrical energy with an improved energy efficiency as well as with a simplified construction of the system, and to provide a hydrogen supply device used in the fuel cell system.

The present invention provides a hydrogen supply device comprising a fuel-side electrode to decompose a fuel whose standard oxidation-reduction potential is equal to or less than zero, a hydrogen-production-side electrode, placed opposite to the fuel-side electrode, for producing hydrogen, and an electrolyte membrane interposed between the fuel-side electrode and the hydrogen-production-side electrode.

In the hydrogen supply device of the present invention, it is preferable that the fuel whose standard oxidation-reduction potential is equal to or less than zero is hydrazine.

The present invention also covers a fuel cell system comprising the hydrogen supply device mentioned above, and a fuel cell unit using hydrogen as the fuel.

In the fuel cell system of the present invention, it is preferable that the fuel cell unit comprises a hydrogen-side electrode to which the hydrogen produced on the hydrogen-production-side electrode is supplied, an oxygen-side electrode to which oxygen or air is supplied, and a polymer electrolyte membrane interposed between the hydrogen-side electrode and the oxygen-side electrode.

The hydrogen supply device of the present invention uses the fuel whose standard oxidation-reduction potential is equal to or less than zero, to promote a spontaneous electrolytic reaction of the fuel. This enables elimination of the need for an external power source for triggering the electrolytic reaction, simplification in construction of the system, and further, generation of the hydrogen with improved energy efficiency. Thus, this fuel cell system of the present invention including this hydrogen supply device can realize the generation of electrical energy with improved energy efficiency as well as with a simplified construction of the system.

### BRIEF DESCRIPTION OF THE DRAWINGS

FIG. 1 is a block schematic diagram showing an embodiment of a fuel cell system of the present invention;

FIG. 2 is a block schematic diagram showing a principal part of an embodiment of a hydrogen supply device of the fuel cell system shown in FIG. 1;

FIG. 3 is a block schematic diagram showing a principal part of an embodiment of a fuel cell unit of the fuel cell system shown in FIG. 1;

FIG. 4 is a correlation diagram showing a relation among an electric current density, a generated voltage, and an amount of hydrogen produced, on the hydrogen supply device (of cation-exchange type) of Example 1; and

FIG. 5 is a correlation diagram showing a relation among an electric current density, a generated voltage, and an amount of hydrogen produced, on the hydrogen supply device (of anion-exchange type) of Example 2.

### DETAILED DESCRIPTION OF THE PREFERRED EMBODIMENTS

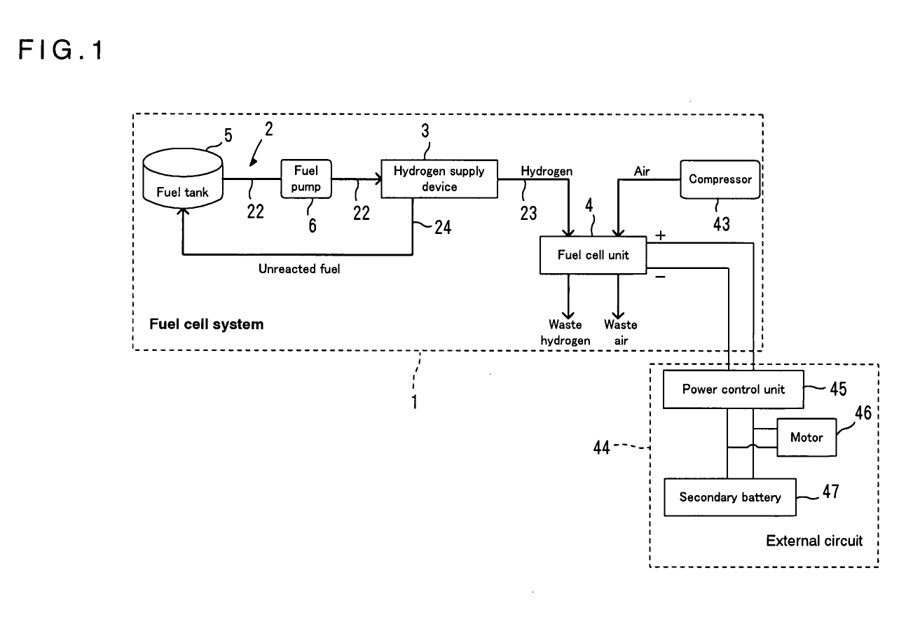

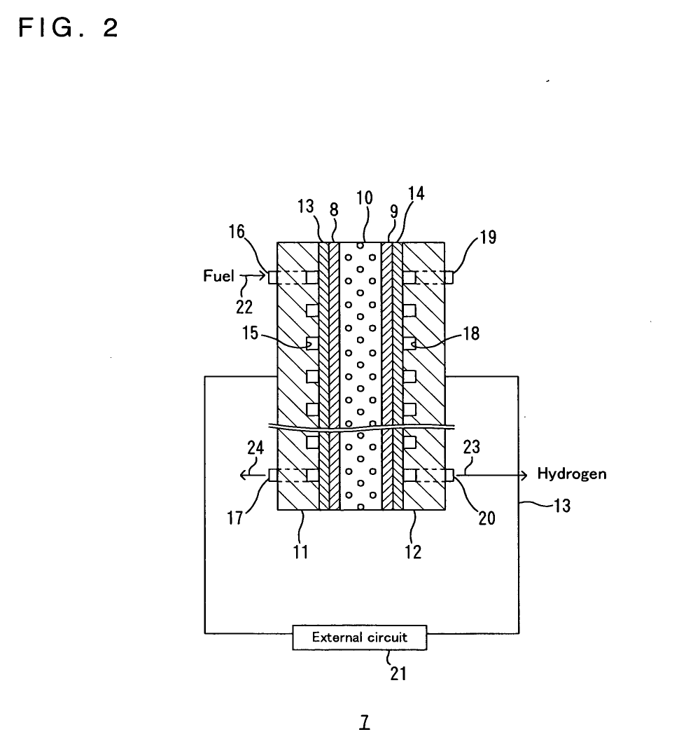

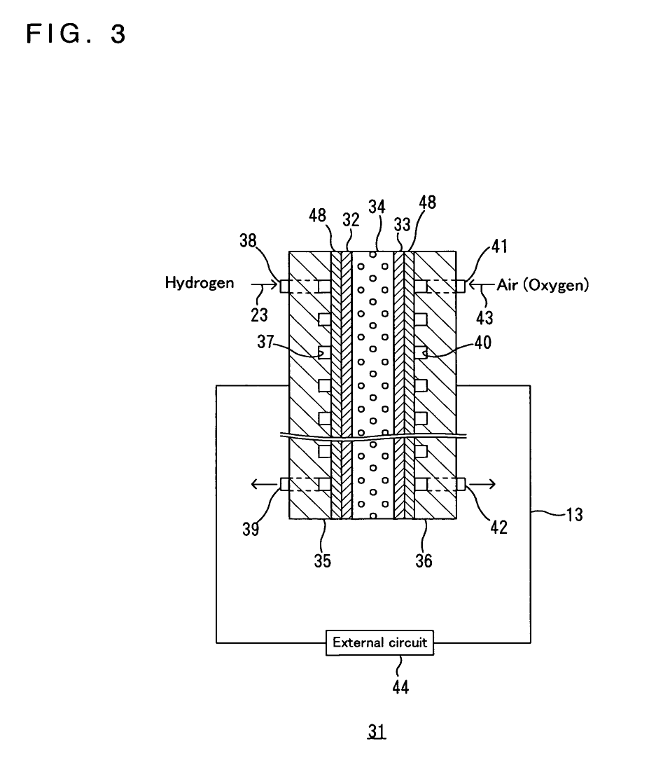

FIG. 1 is a block schematic diagram showing an embodiment of a fuel cell system of the present invention; FIG. 2 is a block schematic diagram showing an embodiment of a hydrogen supply device of the present invention provided in the fuel cell system shown in FIG. 1; and FIG. 3 is a block schematic diagram showing an embodiment of a fuel cell of a fuel cell unit provided in the fuel cell system shown in FIG. 1.

Referring to FIG. 1, the fuel cell system 1 comprises a fuel supply unit 2, a hydrogen supply device 3, and a fuel cell unit 4.

The fuel supply unit 2 includes a fuel tank 5 and a fuel pump 6.

A fuel whose standard redox (oxidation-reduction) potential is equal to or less than zero or whose electric potential difference from an electric potential of a normal hydrogen electrode results in zero or minus numbers is stored in the fuel tank 5. The fuels to be stored in the fuel tank 5 include, for example, hydrazines, such as hydrazine (NH₂NH₂) and hydrazine hydrate (NH₂NH₂—H₂O), ammonia (NH₃), and formic acid (HCOOH). This fuel use can promote a spontaneous electrolytic reaction on a fuel-side electrode 8 of the hydrogen supply device 3, resulting in elimination of the need of the external power source for triggering the electrolytic reaction.

These fuels can be used alone or in combination with two or more. Preferably used are hydrazines and ammonia, and further preferably used are hydrazines. Using hydrazines does not allow any production of CO or CO₂, as mentioned later, thus producing the advantageous result that reduction of catalyst poisoning and substantially zero emission can be achieved.

The fuel pump 6 is connected to the fuel tank 5 and the hydrogen supply device 3 through fuel supply lines 22, to convey the fuel stored in the fuel tank 5 to the hydrogen supply device 3 in a specified amount per unit time.

The hydrogen supply device 3 has a hydrogen producing cell 7 comprising a fuel-side electrode (i.e., an anode-side electrode) 8, a hydrogen-production-side electrode (i.e., a cathode-side electrode) 9, and an electrolyte membrane 10, as shown in FIG. 2. The fuel-side electrode 8 and the hydrogen-production-side electrode 9 are placed opposite to each other to sandwich the electrolyte membrane 10 therebetween.

The fuel-side electrode 8 used is, for example, in the form of a porous electrode of a catalyst support on which a catalyst is supported, though not particularly limited thereto. The fuel-side electrode 8 is placed opposite to the electrolyte membrane 10 to be in contact with one surface of the electrolyte membrane 10.

No particular limitation is imposed on the catalyst used. For example, the elements of the group VIII of the periodic table, such as the elements of the platinum group (Ru, Rh, Pd, Os, Ir, Pt) and the elements of the iron group (Fe, Co, Ni), the elements of the group Ib of the periodic table, such as Cu, Ag, Au, and combinations thereof are used. Pt, Pd, Ni, and Ag are preferably used. In the case where CO is produced secondarily depending on the kind of the fuel, Ru may be used in combination with these elements to prevent the catalyst from being poisoned by the CO.

A conductive porous carrier formed of e.g. carbon and the like may be used as the catalyst support.

The porous electrode can be formed by supporting the catalyst cited above on the catalyst support as mentioned above by a known method. An amount of catalyst supported is, for example, in the range of 0.1 to 5.0 mg/cm², or preferably 0.1 to 1.0 mg/cm².

The fuel-side electrode 8 may be stacked in layer directly on a surface of the electrolyte membrane 10 without supporting the catalyst on the catalyst support. It can then be used as a membrane-electrode conjunction member formed integrally by stacking the electrolyte membrane 10 in layer on the fuel-side electrode 8.

Specifically, the membrane-electrode conjunction member can be formed in the manner that powders of the catalyst cited above (metal blacks) are mixed with and dispersed in electrolyte solution; then, after a viscosity of the resultant solution is adjusted by mixing a proper quantity of organic solvent, the solution is coated on a surface of the electrolyte membrane 10 by a known coating method, such as a spray coating; and after dried, the membrane is hot-pressed to fix the catalyst to a surface of the electrolyte membrane 10. The metal blacks that may be used for the membrane-electrode conjunction member include, for example, Ru black, Rh black, Pd black, Ir black, Pt black, and combinations thereof

The membrane-electrode conjunction member can also be formed by forming the catalytic metal cited above on the surface of the electrolyte membrane 10 by the electroless plating.

An amount of catalyst stacked (supported) directly on the surface of the electrolyte membrane 10 is, for example, in the range of 0.1 to 5.0 mg/cm², or preferably 0.1 to 3.0 mg/cm², as is the case with the above.

The hydrogen-production-side electrode 9 used is, for example, in the form of a porous electrode of a catalyst support on which a catalyst is supported, as is the case with the above, though not particularly limited thereto. The hydrogen-production-side electrode 9 is placed opposite to the electrolyte membrane 10 to be in contact with the other surface of the electrolyte membrane 10. The hydrogen-production-side electrode 9 may be formed directly on the surface of the electrolyte membrane 10 by stacking the hydrogen-production-side electrode 9 in layer directly thereon without supporting the catalyst on the catalyst support, as is the case with the above. It can then be used as a membrane-electrode conjunction member formed integrally by stacking the electrolyte membrane 10 on the hydrogen-production-side electrode 9. The hydrogen-production-side electrode 9 can be formed simultaneously with or separately from the fuel-side electrode 8 in the same stacking manner as the fuel-side electrode 8.

An amount of catalyst supported on the hydrogen-production-side electrode 9 is, for example, in the range of 0.1 to 5.0 mg/cm², or preferably 0.1 to 1.0 mg/cm².

A cation-exchange membrane to allow the shift of the protons (H⁺) produced by the catalyzed reaction of the fuel on the fuel-side electrode 8 or an anion-exchange membrane to allow the shift of hydroxide ion (OH⁻) produced by the catalyzed reaction of the water on the hydrogen-production-side electrode 9 is selectively used as the electrolyte membrane 10 in accordance with a device condition and the like.

The cation-exchange membranes that may be preferably used include, for example, a polymer membrane with an ion-exchange function, such as sulfonic acid, phosphoric acid, and carboxylic acid, introduced into a perfluoro-based-, a partial-fluorine-based-, or a hydrocarbon-based-polymer skeleton. The anion-exchange membranes that may be preferably used include, for example, a polymer membrane with ion-exchange functions, including for example, pyridinium function (quaternary ammonium), introduced into a perfluoro-based-, a partial-fluorine-based-, or a hydrocarbon-based-polymer skeleton. Known cation-exchange membranes and anion-exchange membranes which are commercially available can be used as the electrolyte membrane 10.

The electrolyte membrane 10 is usually moistened by a moisture conditioner, not shown, to be always kept in its moistened state.

The hydrogen producing cell 7 further includes a fuel supply member 11, a hydrogen discharge member 12, a collector 13, and a collector 14 with a gas diffusion layer or zone.

The fuel supply member 11 is formed of a gas-impermeable conductive material and set in place with its one surface confronting the fuel-side electrode 8. Also, the fuel supply member 11 has a fuel-side flow path 15 of e.g. a continuous zigzag groove, formed in its one side confronting the fuel-side electrode 8, to supply the fuel to the entire surface of the fuel-side electrode 8. The fuel supply member 11 has a fuel supply port 16 formed to extend through the fuel supply member 11 in the thickness direction and communicate with an upstream end portion of the fuel-side flow path 15. It also has a fuel discharge port 17 formed to extend through the fuel supply member 11 in the thickness direction and communicate with a downstream end portion of the fuel-side flow path 15.

The fuel pump 6 is connected to the fuel supply port 16 through a fuel supply line 22, and a reflux flow path 24 for an unreacted fuel is connected to the fuel discharge port 17. The reflux flow path 24 is connected to the fuel discharge port 17 at one end thereof and to the fuel tank 5 at the other end thereof, so that the unreacted fuel discharged from the fuel discharge port 17 flows back to the fuel tank 5, as shown in FIG. 1.

As shown in FIG. 2, the hydrogen discharge member 12 is also formed of a gas-impermeable conductive material and set in place with its one surface confronting the hydrogen-production-side electrode 9, as is the case with the fuel supply member 11. The hydrogen discharge member 12 has a hydrogen-production-side flow path 18 of e.g. a continuous zigzag groove, formed in its one side confronting the hydrogen-production-side electrode 9, to discharge the hydrogen gas generated on the hydrogen-production-side electrode 9. The hydrogen discharge member 12 has a supply port 19 formed to extend through the hydrogen discharge member 12 in the thickness direction and communicate with an upstream end portion of the hydrogen-production-side flow path 18. It also has a discharge port 20 formed to extend through the hydrogen discharge member 12 in the thickness direction and communicate with a downstream end portion of the hydrogen-production-side flow path 18.

The supply port 19 is normally closed and is connected to a gas supply line, not shown, when needed. A hydrogen supply line 23 through which the hydrogen gas is sent to the fuel cell unit 4 is connected to the discharge port 20.

The collector 13 is interposed between the fuel supply member 11 and the fuel-side electrode 8 in such a sandwich relation that one side of the collector 13 is in contact with the fuel-side flow path 15 of the fuel supply member 11 and the other side thereof is in contact with the fuel-side electrode 8.

The collector 13 is used to improve permeation of the fuel liquid between the fuel-side electrode 8 and the fuel supply member 11 and transmission efficiency of the electrons (e⁻) generated on the fuel-side electrode 8 to the fuel supply member 11. Porous, conductive material, such as a sintered compact of titanium fiber and a carbon cloth, is used for the collector 13.

The collector 14 with the gas diffusion layer is interposed between the hydrogen discharge member 12 and the hydrogen-production-side electrode 9 in such a sandwich relation that one side of the collector 14 is in contact with the hydrogen-production-side flow path 18 of the hydrogen discharge member 12 and the other side thereof is in contact with the hydrogen-production-side electrode 9.

The collector 14 with the gas diffusion layer is used to improve transmission efficiency of the electrons supplied from an external circuit 21 to the hydrogen-production-side electrode 9 between the hydrogen-production-side electrode 9 and the hydrogen discharge member 12. Gas-permeable, hydrophobic, conductive material, such as a water-shedding carbon cloth, is used for the collector 14 with the gas diffusion layer.

Now, let us consider the case where this hydrogen producing cell 7 uses the cation-exchange membrane as the electrolyte membrane 10, first. In this case, when the above-said fuel is supplied to the fuel-side flow path 15 of the fuel supply member 11, the fuel is put into contact with the fuel-side electrode 8 through the collector 13, to cause a catalyzed reaction to dissolve the fuel into protons and electrons, and nitrogen (CO, CO₂, etc. may also be produced concurrently, depending on the kind of the fuel compound). Then, the protons pass through the electrolyte membrane 10 and shift to the hydrogen-production-side electrode 9, and the electrons pass through the external circuit 21 and shift to the hydrogen-production-side electrode 9 as mentioned later. These protons and electrons are bonded to each other at the hydrogen-production-side electrode 9 to thereby produce the hydrogen gas. The hydrogen gas thus produced permeates through the collector 14 with the gas diffusion layer and is discharged to the hydrogen-production-side flow path 18 and sent out from the discharge port 20 to the fuel cell unit 4 through the hydrogen supply line 23.

To be more specific, for example, when hydrazine is used as the fuel, the reaction of the formula (1) given below is promoted by the catalyst on the fuel-side electrode 8.
NH₂NH₂→N₂+4H⁺+4e⁻ (1)
Also, the protons H⁺ produced in accordance with the above-said formula (1) and passed through the electrolyte membrane 10 and the electrons e⁻ passed through the external circuit 21, mentioned later, are bonded to each other at the hydrogen-production-side electrode 9, as shown in the formula (2) given below, to thereby produce the hydrogen gas.
4H⁺+4e⁻→2H₂ (2)

Thus, when hydrazine is used as the fuel, the hydrogen-nitrogen bonding and the nitrogen-nitrogen bonding of the hydrazine can facilitate the production of nitrogen and protons by the catalyzed reaction, thus realizing the efficient electrolytic reaction, while preventing the catalyst from being poisoned. Besides, since hydrazine includes no carbon, neither CO nor CO₂ is produced at the fuel-side electrode 8 but only nitrogen is produced thereat. Due to this, the catalyst is prevented from being poisoned, thus achieving improved durability and further achieving substantially zero emission.

Next, let us consider the case where the hydrogen producing cell 7 uses the anion-exchange membrane as the electrolyte membrane 10. In this case, when the water contained in the electrolyte membrane 10 or a moistened inert gas, if necessary, is supplied from a gas supply line (not shown) to the supply port 19 of the hydrogen-production-side flow path 18, the water contained in the inert gas is put into contact with the hydrogen-production-side electrode 9, to react with the electrons supplied via the external circuit 21 to thereby produce hydroxide ions and hydrogen. The hydroxide ions are passed through the electrolyte membrane 10 and shifted to the fuel-side electrode 8. The fuel supplied to the fuel-side flow path 15 of the fuel supply member 11 is put into contact with the fuel-side electrode 8 through the collector 13, to react with the hydroxide irons to produce water and nitrogen (CO, CO₂, etc. may also be produced concurrently, depending on the kind of the fuel). The electrons are produced at that time. Then, the electrons produced are supplied to the hydrogen-production-side electrode 9 via the external circuit 21 to continuously produce hydrogen. The hydrogen gas produced is discharged from the collector 14 with the gas diffusion layer to the hydrogen-production-side flow path 18 and sent out from the discharge port 20 to the fuel cell unit 4 through the hydrogen supply line 23.

To be more specific, the electrolytic reaction of water of the formula (3) given below is promoted by the catalyst on the hydrogen-production-side electrode 9. Also, for example when hydrazine is used as the fuel, the reaction of the formula (4) given below is promoted by the catalyst on the fuel-side electrode 8.
4H₂O+4e⁻→4OH⁻+2H₂ (3)
NH₂NH₂+4OH⁻→N₂+4H₂O+4e⁻ (4)

Thus, when hydrazine is used as the fuel, the hydrogen-nitrogen bonding and the nitrogen-nitrogen bonding of the hydrazine can facilitate the production of nitrogen and water by the catalyzed reaction as mentioned above, thus realizing the efficient electrolytic reaction, while preventing the catalyst from being poisoned. Besides, since hydrazine includes no carbon, neither CO nor CO₂ is produced at the fuel-side electrode 8 but only nitrogen and water are produced thereat. Due to this, the catalyst is prevented from being poisoned, thus achieving improved durability and further achieving substantially zero emission.

In this electrolytic reaction, it is usual that the hydrogen-production-side flow path 18 of the hydrogen discharge member 12 can be used only for discharging the hydrogen gas by closing the supply port 19. But, in the case where moisture must be supplied from exterior without relying on the water contained in the electrolyte membrane 10, for moistening the electrolyte membrane 10 or in using the anion-exchange membrane as the electrolyte membrane 10, a gas supply line, not shown, can be connected to the supply port 19 to supply a moistened inert gas.

No particular limitation is imposed on the external circuit 21, as long as it can allow electrical connection between the fuel-side supply member 11 and the hydrogen discharge member 12. For example, when an electromotive force generated in this hydrogen producing cell 7 is large, the external circuit 21 may be configured as a power source of an auxiliary device (e.g. the above-said fuel pump) annexed to the fuel cell system 1. On the other hand, when the electromotive force is small, the external circuit 21 may be configured as a short circuit to directly connect between the fuel-side supply member 11 and the hydrogen discharge member 12 to produce a maximum amount of hydrogen.

The hydrogen supply device 3 is industrially used in the form of the stack structure wherein a plurality of hydrogen producing cells 7 are stacked in layers. For example, a known stack structure found in a direct methanol fuel cell and the like can be adopted for the stuck structure. For example, the fuel-side supply member 11 and the hydrogen discharge member 12 may be configured in the form of a separator having the fuel-side flow path 15 and the hydrogen-production-side flow path 18 at both sides thereof.

The fuel cell unit 4 includes a cell 31(single cell) of the fuel cell shown in FIG. 3. In FIG. 3, the cell 31 comprises an electrolyte membrane 34 as a ion conduction material, a hydrogen-side electrode 32, an oxygen-side electrode 33, a hydrogen supply member 35, an oxygen supply member 36, and two collectors 48 with gas diffusion layers.

The electrolyte membrane 34 is formed of a cation-exchange polymer electrolyte membrane or an anion-exchange polymer electrolyte membrane. To be more specific, for example a perfluoro sulfonic acid membrane is used as the electrolyte membrane 34.

The hydrogen-side electrode 32 and the oxygen-side electrode 33 are placed to sandwich the electrolyte membrane 34 from both sides thereof. The hydrogen supply member 35 and the oxygen supply member 36 are placed to sandwich the hydrogen-side electrode 32 and oxygen-side electrode 33 from further outside thereof The two collectors 48 with gas diffusion layers are provided between the hydrogen-side electrode 32 and the hydrogen supply member 35 and between the oxygen-side electrode 33 and the oxygen supply member 36, respectively.

The hydrogen-side electrode 32 and the oxygen-side electrode 33 are formed of a conductive carrier having a large surface area supporting thereon a noble metal, such as carbon black.

The hydrogen supply member 35 is formed of a gas-impermeable conductive material and set in place with its one surface confronting the hydrogen-side electrode 32. The hydrogen supply member 35 has a hydrogen-supply-side flow path 37 of e.g. a continuous zigzag groove, formed in its one side confronting the hydrogen-side electrode 32, to supply the hydrogen gas to the entire surface of the hydrogen-side electrode 32. The hydrogen supply member 35 also has a supply port 38 formed to extend through the hydrogen supply member 35 in the thickness direction and communicate with an upstream end portion of the hydrogen-supply-side flow path 37. It also has a discharge port 39 formed to extend through the hydrogen supply member 35 in the thickness direction and communicate with a downstream end portion of the hydrogen-supply-side flow path 37.

A hydrogen supply line 23 connected with the hydrogen supply device 3 is connected to the supply port 38, and a drain, not shown, is connected to the discharge port 39.

The oxygen supply member 36 is formed of a gas-impermeable conductive material and set in place with its one surface confronting the oxygen-side electrode 33. The oxygen supply member 36 has an oxygen-side flow path 40 of e.g. a continuous zigzag groove, formed in its one side confronting the oxygen-side electrode 33, to supply the air (oxygen) to the entire surface of the oxygen-side electrode 33. The oxygen supply member 36 also has an oxygen supply port 41 formed to extend through the oxygen supply member 36 in the thickness direction and communicate with an upstream end portion of the oxygen-side flow path 40. It also has a discharge port 42 formed to extend through the oxygen supply member 36 in the thickness direction and communicate with a downstream end portion of the oxygen-side flow path 40.

A compressor 43 is connected to the oxygen supply port 41, and a drain, not shown, is connected to the oxygen discharge port 42.

The collectors 48 with gas diffusion layers are formed of the same material as that of the collector 14 with the gas diffusion layer of the hydrogen supply device 3 mentioned above and are interposed between the hydrogen-side electrode 32 and the hydrogen supply member 35 and between the oxygen-side electrode 33 and the oxygen supply member 36, respectively.

In this cell 31, hydrogen gas is supplied from the hydrogen supply device 3 to the supply port 38 of the hydrogen supply member 35 through the hydrogen supply line 23 and the air (oxygen) is supplied from the compressor 43 to the oxygen supply port 41 of the oxygen supply member 36. Then, the hydrogen gas is supplied from the hydrogen-supply-side flow path 37 to the hydrogen-side electrode 32 through the collector 48 with the gas diffusion layer. In the case where the electrolyte membrane 34 is a proton-exchange membrane, the reaction of the formula (5) given below is promoted.
H₂→2H⁺+2e⁻ (5)

The protons H⁺ produced in accordance with the formula (5) shown above and passed through the electrolyte membrane 34 and the electrons passed through the external circuit 44 mentioned layer, and the oxygen in the air supplied from the compressor 43 through the oxygen-side flow path 40 are allowed to react with each other in accordance with the formula (6) given below on the oxygen-side electrode 33, to produce water. In this electrolytic reaction, an electromotive force is generated in the external circuit 44.
½O₂+2H⁺+2e⁻→H₂O (6)

This fuel cell unit 4 is industrially used in the form of a known stack structure wherein a plurality of cells 31 are stacked in layers. In order to configure the fuel cell unit 4 into the stack structure, for example, the hydrogen supply member 35 and the oxygen supply member 36 may be configured in the form of a separator having the hydrogen-supply-side flow path 37 and the oxygen-side flow path 40 at both sides thereof.

Any known fuel cells using hydrogen as the fuel gas may be used for the fuel cell unit 4, regardless of the embodied form described above.

The external circuit 44 is provided as a circuit to allow electrical connection between the hydrogen supply member 35 and the oxygen supply member 36. No particular limitation is imposed on the external circuit 44. For example, when this fuel cell system 1 is equipped on the automotive vehicle, the external circuit 44 may be configured in the form of a known circuit to deliver the electric power to a motor 46 and a secondary battery 47 from a power control unit 45, as shown FIG. 1.

In this fuel cell system 1, a fuel whose standard oxidation-reduction potential is equal to or less than zero is supplied to the hydrogen supply device 3 to produce the hydrogen gas in the hydrogen supply device 3 and, then, the hydrogen gas thus produced therein is supplied to the fuel cell unit 4 to thereby generate electricity in the fuel cell unit 4 using the hydrogen gas as the fuel. This fuel cell system 1 can allow realization of generation of electricity with improved energy efficiency as well as with a simplified construction of the system.

Specifically, since the fuel whose standard oxidation-reduction potential is equal to or less than zero is supplied to the hydrogen supply device 3, the electrolytic reaction is spontaneously promoted at the closed circuit.

To be more specific, the promotion of the electrolytic reaction mentioned above requires that the fuel-side electrode (anode-side electrode) 8 be smaller in oxidation-reduction potential than the hydrogen-production-side electrode (cathode-side electrode) 9 (i.e., fuel-side electrode 8<hydrogen-production-side electrode 9) and that the potential difference can afford to fully cover an energy loss required for the promotion of the electrolytic reaction. In this electrolytic reaction, if the standard oxidation-reduction potential of the fuel is equal to or less than zero, then the hydrogen producing reaction can be spontaneously caused in the hydrogen-production-side electrode 9 by minimizing an energy loss required for the reaction. In contrast to this, for example when methanol is used as the fuel, the oxidation-reduction potential results in the fuel-side electrode 8>hydrogen-production-side electrode 9, so there is no possibility that the spontaneous reaction is caused. In addition, since the energy (overpotential) required for oxidation of the methanol is also large, the promotion of the electrolytic reaction requires that the corresponding energy be continuously supplied from exterior.

The hydrogen supply device 3 can eliminate the need to trigger the electrolytic reaction by the electric power from the external power source, differently from the case where the methanol is used as the fuel, and thus can eliminate the need of such an external power source. Also, after the operation of the fuel cell unit 4, the electric energy generated in the fuel cell unit 4 need not be supplied to the hydrogen supply device 3 to promote the production of the hydrogen gas in the hydrogen supply device 3. This can eliminate the need of the specific circuit therefor. As a result, the construction of the system can be simplified very much.

Further, when methanol is used as the fuel, the production of the hydrogen gas must be promoted in the hydrogen supply device 3 by using the electric power generated in the fuel cell unit 4, so a part of the electric power generated in the fuel cell unit 4 must be supplied to the hydrogen supply device 3. Consequently, reduction of energy efficiency is unavoidable. In contrast to this, this fuel cell system 1 can produce the hydrogen gas efficiently by the spontaneous electrolytic reaction of the fuel, without supplying the electric power to the hydrogen supply device 3. This can prevent reduction of the energy efficiency to that extent, achieving the generation of electric energy with improved energy efficiency.

Accordingly, this hydrogen supply device 3 can be used as a substitution for a known reformer to reform fuel liquid to hydrogen gas. Hence, the fuel cell system 1 including this hydrogen supply device 3 can be widely used in a variety of fields without any particular limitation, including power sources for transportation vehicles and machines, such as power sources for automobiles, power sources for small, portable, outdoor type generators, and power sources for portable home electric appliances.

### EXAMPLES

In the following, the present invention is described further specifically with reference to Examples. The present invention is not in any manner limited to these Examples.

### Example 1

1) Production of Membrane-electrode Conjunction Member:

With H₂PtCl₆ solution and NaBH₄ (reducing agent) placed at both sides of the electrolyte membrane 10 of a cation-exchange, perfluoro-based, polymer electrolyte membrane (Nafion 117 ® available from Du Pont), the fuel-side electrode 8 of Pt and the hydrogen-production-side electrode 9 of Pt were formed on the both sides of the electrolyte membrane 10, respectively, by electroless plating. An amount of Pt supported on each side of the electrolyte membrane was 1 mg/cm². The membrane-electrode conjunction member obtained had a circular form and the electrode area was 10 cm².

2) Production of Hydrogen Supply Device:

A sintered compact of titanium fiber was used for the collector 13 and a carbon cloth coated with a water-shedding carbon layer was used for the collector 14 with gas diffusion layer. The membrane-electrode conjunction member including the fuel-side electrode 8 and hydrogen-production-side electrode 9 formed on both sides of the electrolyte membrane 10, the collector 13, and the collector 14 with gas diffusion layer were held in a sandwich relation in a testing hydrogen producing cell 7 in which the fuel supply member 11 and the hydrogen discharge member 12 were preset, thereby producing the hydrogen supply device 3.

3) Measurements of Amount of Hydrogen Produced and Generated Voltage:

An aqueous solution of hydrazine-hydrate (N₂H₄—H₂O) prepared to 2 mol/L was forced to flow through the fuel supply member 11 at a flow rate of 2 mL/min, and argon gas moistened to 60° C. was forced to flow through the hydrogen discharge member 12 at a flow rate of 200 mL/min. The hydrogen producing cell 7 was adjusted in temperature to 60° C.

A current pulse generator for adjusting electric current (HC-115, available from HOKUTO DENKO CORPORATION) was connected as the external circuit 21, and the generated voltage was measured, while the electric current was adjusted using the current pulse generator. Also, an amount of hydrogen produced was measured by measuring the hydrogen produced in the hydrogen discharge member 12 by using a gas flow rate measuring device and a gas chromatograph.

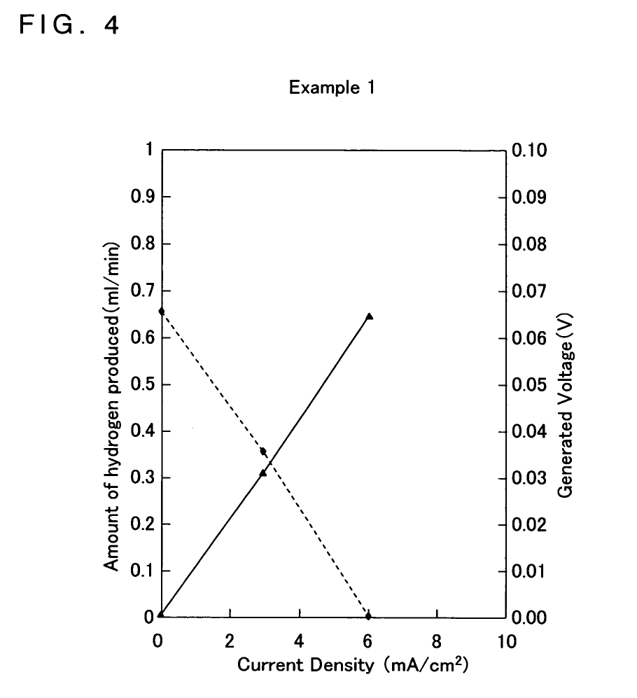

The results are shown in FIG. 4.

### Example 2

1) Production of Membrane-electrode Conjunction Member:

With Pt(NH₄)₆Cl₄ solution and NaBH₄ (reducing agent) placed at both sides of the electrolyte membrane 10 of an anion-exchange, perfluoro-based, polymer electrolyte membrane (Tosflex SF-17 ® available from Tosoh Corporation), the fuel-side electrode 8 of Pt and the hydrogen-production-side electrode 9 of Pt were formed on the both sides of the electrolyte membrane 10, respectively, by electroless plating. An amount of Pt supported on each side of the electrolyte membrane 10 was 1 mg/cm². The membrane-electrode conjunction member obtained had a circular form and the electrode area was 10 cm².

2) Production of Hydrogen Supply Device:

A sintered compact of titanium fiber was used for the collector 13 and a carbon cloth was used for the collector 14 with gas diffusion layer. The membrane-electrode conjunction member including the fuel-side electrode 8 and hydrogen-production-side electrode 9 formed on both sides of the electrolyte membrane 10, the collector 13, and the collector 14 with gas diffusion layer were held in a sandwich relation in a testing hydrogen producing cell 7 in which the fuel supply member 11 and the hydrogen discharge member 12 were preset, thereby producing the hydrogen supply device 3.

3) Measurements of Amount of Hydrogen Produced and Generated Voltage:

An aqueous solution of hydrazine-hydrate (N₂H₄—H₂O) prepared to 2 mol/L was forced to flow through the fuel supply member 11 at a flow rate of 2 mL/min, and argon gas moistened to 60° C. was forced to flow through the hydrogen discharge member 12 at a flow rate of 200 mL/min. The hydrogen producing cell 7 was adjusted in temperature to 60° C.

The current pulse generator for adjusting electric current (HC-115, available from HOKUTO DENKO CORPORATION) was connected as the external circuit 21, and the generated voltage was measured, while the electric current was adjusted using the current pulse generator. Also, an amount of hydrogen produced was measured by measuring the hydrogen produced in the hydrogen discharge member 12 by using the gas flow rate measuring device and the gas chromatograph.

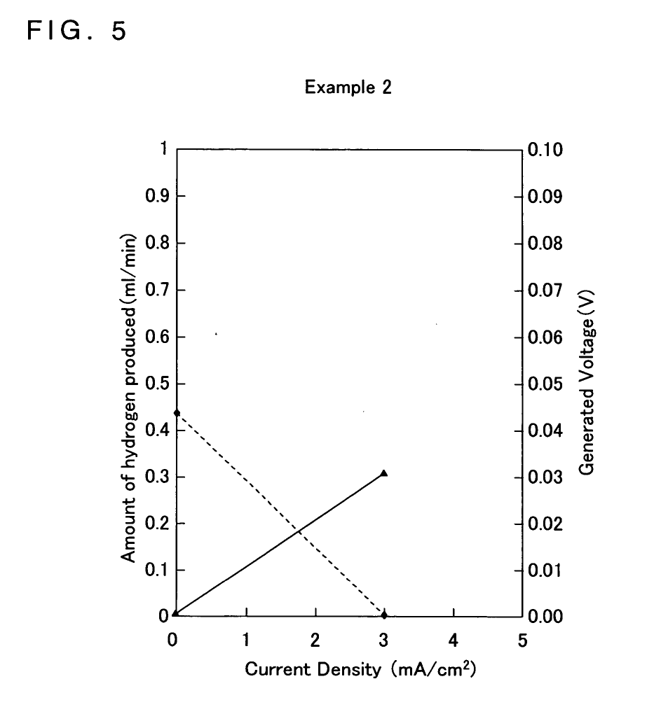

The results are shown in FIG. 5.

As apparent from FIGS. 4 and 5, the hydrogen supply devices 3 of Examples 1 and 2 generated the electromotive force ranging from 0.04V-0.07V at the closed circuit. As the current density increased, the amount of hydrogen produced (solid line) increased, while on the other hand, the generated voltage (dotted line) decreased. When the generated voltage became zero, a maximum current value (=a maximum amount of hydrogen produced) as spontaneously obtained was observed.

While the illustrative embodiments and examples of the present invention are provided in the above description, such is for illustrative purpose only and it is not to be construed restrictively. Variants of the present invention that will be obvious to those skilled in the art is to be covered by the following claims.

1. A hydrogen supply device comprising a fuel-side electrode to decompose a fuel whose standard oxidation-reduction potential is equal to or less than zero, a hydrogen-production-side electrode, placed opposite to the fuel-side electrode, for producing hydrogen, and an electrolyte membrane interposed between the fuel-side electrode and the hydrogen-production-side electrode.

2. The hydrogen supply device according to claim 1, wherein the fuel whose standard oxidation-reduction potential is equal to or less than zero is hydrazine.

3. A fuel cell system comprising a hydrogen supply device comprising a fuel-side electrode to decompose a fuel whose standard oxidation-reduction potential is equal to or less than zero, a hydrogen-production-side electrode, placed opposite to the fuel-side electrode, for producing hydrogen, and an electrolyte membrane interposed between the fuel-side electrode and the hydrogen-production-side electrode, and a fuel cell unit using hydrogen as the fuel.

4. The fuel cell system according to claim 3, wherein the fuel whose standard oxidation-reduction potential is equal to or less than zero is hydrazine.

5. The fuel cell system according to claim 3, wherein the fuel cell unit comprising a hydrogen-side electrode to which the hydrogen produced on the hydrogen-production-side electrode is supplied, an oxygen-side electrode to which oxygen or air is supplied, and a polymer electrolyte membrane interposed between the hydrogen-side electrode and the oxygen-side electrode.
